(19) United States
(12) Patent Application Publication
(10) Pub. No.: US 2020/0242155 A1
(43) Pub. Date: Jul. 30, 2020

(54) SEARCH APPARATUS, SEARCH METHOD, AND NON-TRANSITORY STORAGE MEDIUM

(71) Applicant: NEC Corporation, Tokyo (JP)

(72) Inventors: Jianquan LIU, Tokyo (JP); Sheng HU, Tokyo (JP)

(73) Assignee: NEC Corporation, Tokyo (JP)

(21) Appl. No.: 16/755,930

(22) PCT Filed: Oct. 15, 2018
(86) PCT No.: PCT/JP2018/038338

§ 371 Date: Apr. 14, 2020

(30) Foreign Application Priority Data
Oct. 16, 2017 (JP) 2017-200103

(51) Int. Cl. G06F 16/783; G06F 16/71; G06K 9/00

(52) U.S. Cl. CPC G06F 16/786; G06K 9/00744; G06K 9/00718; G06F 16/71

(57) ABSTRACT

A search apparatus (10) including a storage unit (11) that stores video index information including correspondence information which associates a type of one or a plurality of objects extracted from a video with a motion of the object, an acquisition unit (12) that acquires a search key associating the type of one or the plurality of objects as a search target with the motion of the object, and a search unit (13) that searches the video index information on the basis of the search key is provided.

### TECHNICAL FIELD

The present invention relates to a search apparatus, a terminal apparatus, an analysis apparatus, a search method, an operation method of a terminal apparatus, an analysis method, and a program.

### BACKGROUND ART

Patent Document 1 discloses a technology for inputting an approximate shape of a figure drawn on a display screen by a user, extracting an object similar to the shape of the figure drawn by the user from a database of images and objects, arranging the extracted object at a position corresponding to the figure drawn by the user, and compositing the object with a background image or the like as a drawing, and thus completing one image not having awkwardness to output eh image.

Non-Patent Document 1 discloses a video search technology based on a handwritten image. In this technology, in a case where an input of the handwritten image is received in an input field, a scene similar to the handwritten image is searched and output. In addition, a figure similar to a handwritten figure is presented as a possible input. When one possible input is selected, the handwritten figure in the input field is replaced with the selected figure.

### RELATED DOCUMENT

### Patent Document

[Patent Document 1] Japanese Patent Application Publication No. 2011-2875

[Patent Document 2] International Publication No. 2014/109127

[Patent Document 3] Japanese Patent Application Publication No. 2015-49574

### Non-Patent Document

[Non-Patent Document 1] Claudiu Tanase and 7 others, “Semantic Sketch-Based Video Retrieval with Auto completion”, [Online], [Searched on Sep. 5, 2017], Internet <URL: https://iui.ku.edu.tr/sezgin_publications/2016/Sezgin-IUI-2016.pdf>

### SUMMARY OF THE INVENTION

### Technical Problem

In a case of a “scene search using only an image as a key” as disclosed in Non-Patent Document 1, search results may not be sufficiently narrowed down. An object of the present invention is to provide a new technology for searching for a desired scene.

### Solution to Problem

According to the present invention, there is provided a search apparatus including a storage unit that stores video index information including correspondence information which associates a type of one or a plurality of objects extracted from a video with a motion of the object, an acquisition unit that acquires a search key associating the type of one or the plurality of objects as a search target with the motion of the object, and a search unit that searches the video index information on the basis of the search key.

In addition, according to the present invention, there is provided a terminal apparatus including a display control unit that displays a search screen on a display, the search screen including an icon display area which selectably displays a plurality of icons respectively indicating a plurality of predefined motions, and an input area which receives an input of a search key, an input reception unit that receives an operation of moving any of the plurality of icons into the input area and receives a motion indicated by the icon positioned in the input area as the search key, and a transmission and reception unit that transmits the search key to a search apparatus and receives a search result from the search apparatus.

In addition, according to the present invention, there is provided an analysis apparatus including a detection unit that detects an object from a video on the basis of information indicating a feature of an appearance of each of a plurality of types of objects, a motion determination unit that determines to which of a plurality of predefined motions the detected object corresponds, and a registration unit that registers the type of object detected by the detection unit in association with a motion of each object determined by the determination unit.

In addition, according to the present invention, there is provided a search method executed by a computer, the method comprising storing video index information including correspondence information that associates a type of one or a plurality of objects extracted from a video with a motion of the object, an acquisition step of acquiring a search key associating the type of one or the plurality of objects as a search target with the motion of the object, and a search step of searching the video index information on the basis of the search key.

In addition, according to the present invention, there is provided a program causing a computer to function as a storage unit that stores video index information including correspondence information that associates a type of one or a plurality of objects extracted from a video with a motion of the object, an acquisition unit that acquires a search key associating the type of one or the plurality of objects as a search target with the motion of the object, and a search unit that searches the video index information on the basis of the search key.

In addition, according to the present invention, there is provided an operation method of a terminal apparatus executed by a computer, the method comprising a display control step of displaying a search screen on a display, the search screen including an icon display area which selectably displays a plurality of icons respectively indicating a plurality of predefined motions, and an input area which receives an input of a search key, an input reception step of receiving an operation of moving any of the plurality of icons into the input area and receiving a motion indicated by the icon positioned in the input area as the search key, and a transmission and reception step of transmitting the search key to a search apparatus and receiving a search result from the search apparatus.

In addition, according to the present invention, there is provided a program causing a computer to function as a display control unit that displays a search screen on a display, the search screen including an icon display area which selectably displays a plurality of icons respectively indicating a plurality of predefined motions, and an input area which receives an input of a search key, an input reception unit that receives an operation of moving any of the plurality of icons into the input area and receives a motion indicated by the icon positioned in the input area as the search key, and a transmission and reception unit that transmits the search key to a search apparatus and receives a search result from the search apparatus.

In addition, according to the present invention, there is provided an analysis method executed by a computer, the method comprising a detection step of detecting an object from a video on the basis of information indicating a feature of an appearance of each of a plurality of types of objects, a motion determination step of determining to which of a plurality of predefined motions the detected object corresponds, and a registration step of registering the type of object detected in the detection step in association with a motion of each object determined in the determination step.

In addition, according to the present invention, there is provided a program causing a computer to function as a detection unit that detects an object from a video on the basis of information indicating a feature of an appearance of each of a plurality of types of objects, a motion determination unit that determines to which of a plurality of predefined motions the detected object corresponds, and a registration unit that registers the type of object detected by the detection unit in association with a motion of each object determined by the determination unit.

### Advantageous Effects of Invention

According to the present invention, a new technology for searching for a desired scene is realized.

### BRIEF DESCRIPTION OF THE DRAWINGS

The above object, and other objects, features, and advantages will become more apparent from preferred example embodiments set forth below and the following drawings appended thereto.

FIG. 1 is a diagram illustrating one example of a function block diagram of a search system of the present example embodiment.

FIG. 2 is a diagram illustrating one example of a function block diagram of a search apparatus of the present example embodiment.

FIG. 3 is a diagram schematically illustrating one example of correspondence information included in video index information of the present example embodiment.

FIG. 4 is a flowchart illustrating one example of a flow of process of the search apparatus of the present example embodiment.

FIG. 5 is a diagram schematically illustrating another example of the correspondence information included in the video index information of the present example embodiment.

FIG. 6 is a diagram schematically illustrating one example of a data representation of the correspondence information of the present example embodiment.

FIG. 7 is a diagram illustrating types of pred_i in FIG. 6.

FIG. 8 is one example of a diagram in which a segment ID and the correspondence information are associated for each video file.

FIG. 9 is a diagram in which a type of object and relevant information are associated.

FIG. 10 is a diagram conceptually illustrating one example of index information of a tree structure.

FIG. 11 is one example of a diagram in which a node ID and the relevant information are associated.

FIG. 12 is one example of a diagram illustrating, for each type of object, whether or not each object appears in a scene represented by a flow of nodes.

FIG. 13 is another example of the diagram illustrating, for each type of object, whether or not each object appears in the scene represented by the flow of nodes.

FIG. 14 is a diagram illustrating one example of a data representation of a search key of the present example embodiment.

FIG. 15 is a diagram illustrating a specific example of the data representation of the search key of the present example embodiment.

FIG. 16 is a diagram illustrating one example of a function block diagram of an analysis apparatus of the present example embodiment.

FIG. 17 is a diagram schematically illustrating one example of index information used in a process of grouping objects having similar appearances.

FIG. 18 is a diagram illustrating one example of a function block diagram of a terminal apparatus of the present example embodiment.

FIG. 19 is a diagram schematically illustrating one example of a screen displayed by the terminal apparatus of the present example embodiment.

FIG. 20 is a diagram illustrating one example of a hardware configuration of the apparatuses of the present example embodiment.

### DESCRIPTION OF EMBODIMENTS

### <First Example Embodiment>

First, a summary of a search system of the present example embodiment will be described. The search system stores video index information including correspondence information in which a type (example: a person, a bag, a car, and the like) of one or a plurality of objects extracted from a video and a motion of the object are associated. When a search key that associates the type of one or the plurality of objects as a search target with the motion of the object is acquired, the video index information is searched based on the search key, and a result is output. The search system of the present example embodiment can search for a desired scene using the motion of the object as a key. An appearance of the object appearing in the video may not stick out in mind, but the motion of the object may be clearly recalled. For example, in such a case, the search system of the present example embodiment that can perform a search using the motion of the object as a key can be used for searching for the desired scene.

For example, the video may be a video continuously captured by a surveillance camera fixed at a certain position, a content (a movie, a television program, an Internet video, or the like) produced by a content producer, a private video captured by an ordinary person, or the like. According to the search system of the present example embodiment, the desired scene can be searched from such a video.

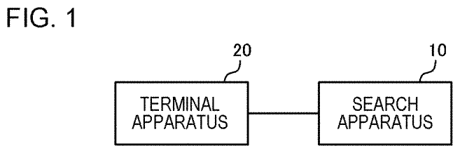

Next, a configuration of the search system of the present example embodiment will be described in detail. As illustrated in the function block diagram of FIG. 1, the search system of the present example embodiment includes a search apparatus 10 and a terminal apparatus 20. The search apparatus 10 and the terminal apparatus 20 are configured to be communicable with each other in a wired and/or wireless manner. For example, the search apparatus 10 and the terminal apparatus 20 may directly (without passing through another apparatus) communicate in a wired and/or wireless manner. Besides, for example, the search apparatus 10 and the terminal apparatus 20 may communicate in a wired and/or wireless manner through a public and/or private communication network (through another apparatus). The search system is a so-called client-server system. The search apparatus 10 functions as a server, and the terminal apparatus 20 functions as a client.

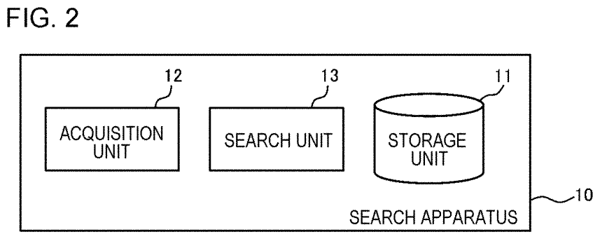

Next, a functional configuration of the search apparatus 10 will be described. FIG. 2 illustrates one example of a function block diagram of the search apparatus 10. As illustrated, the search apparatus 10 includes a storage unit 11, an acquisition unit 12, and a search unit 13.

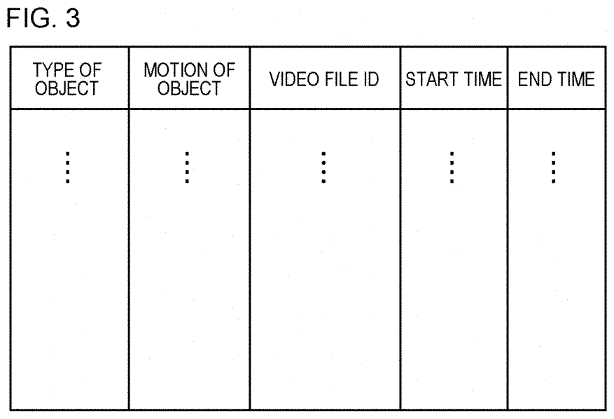

For example, the storage unit 11 stores the video index information including the correspondence information illustrated in FIG. 3. In the illustrated correspondence information, information (a video file identifier (ID)) for identifying a video file including each scene, information (a start time and an end time) for identifying a position of each scene in the video file, the type of one or the plurality of objects extracted from each scene, and the motions of each type of object in each scene are associated. The start time and the end time may be an elapsed time from a head of the video file.

For example, the type of object may be a person, a dog, a cat, a bag, a car, a motorcycle, a bicycle, a bench, or a post. Note that the illustrated type of object is merely one example. Other types may be included, or the illustrated type may not be included. In addition, the illustrated type of object may be further categorized in detail. For example, the person may be categorized in detail as an adult, a child, an aged person, or the like. In a field of the type of object, the type of one object may be described, or the type of a plurality of objects may be described.

For example, the motion of the object may be indicated by a change of a relative positional relationship between a plurality of objects. Specifically, examples such as “a plurality of objects approach each other”, “a plurality of objects move away from each other”, and “a plurality of objects maintain a certain distance from each other” are illustrated but are not for limitation purposes. For example, in a case of a scene including a state where the person approaches the bag, the correspondence information in which “person (type of object)”, “bag (type of object)”, and “approaching each other (motion of object)” are associated is stored in the storage unit 11.

Besides, the motion of the object may include “standing still”, “wandering”, and the like. For example, in a case of a scene including a state where the person is standing still at a certain position, the correspondence information in which “person (type of object)” and “standing still (motion of object)” are associated is stored in the storage unit 11.

The video index information may be automatically generated by causing a computer to analyze the video, or may be generated by causing a person to analyze the video. An apparatus (analysis apparatus) that generates the video index information by analyzing the video will be described in the following example embodiment.

Returning to FIG. 2, the acquisition unit 12 acquires the search key that associates the type of one or a plurality of objects as a search target with the motion of the object. The acquisition unit 12 acquires the search key from the terminal apparatus 20.

The terminal apparatus 20 has an input-output function. In a case where the terminal apparatus 20 receives an input of the search key from a user, the terminal apparatus 20 transmits the received search key to the search apparatus 10. Then, in a case where the terminal apparatus 20 receives a search result from the search apparatus 10, the terminal apparatus 20 displays the search result on a display. For example, the terminal apparatus 20 is a personal computer (PC), a smartphone, a tablet, a portable game console, or a terminal dedicated to the search system. Note that a further detailed functional configuration of the terminal apparatus 20 will be described in the following example embodiment.

The search unit 13 searches the video index information on the basis of the search key acquired by the acquisition unit 12. Then, the search unit 13 extracts the correspondence information matching the search key. For example, the search unit 13 extracts the correspondence information in which the object of the type indicated by the search key is associated with the motion of the object indicated by the search key. Consequently, a scene that is determined as a scene (a scene determined by the video file ID, the start time, and the end time included in the extracted correspondence information; refer to FIG. 3) matching the search key is searched for.

An output unit (not illustrated) of the search apparatus 10 transmits the search result to the terminal apparatus 20. For example, the output unit may transmit information (the video file and the start time and the end time of the searched scene) for playback of the scene determined by the correspondence information extracted by the search unit 13 to the terminal apparatus 20 as the search result. In a case where a plurality of pieces of correspondence information are extracted, the information may be transmitted to the terminal apparatus 20 in association with each piece.

The terminal apparatus 20 displays the search result received from the search apparatus 10 on the display. For example, a plurality of videos may be displayed to be able to be played back in a list.

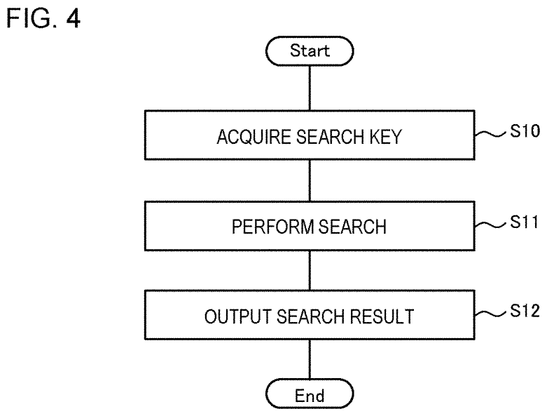

Next, one example of a flow of process of the search apparatus 10 will be described using the flowchart of FIG. 4.

In a case where the acquisition unit 12 acquires the search key associating the type of one or a plurality of objects as a search target with the motion of the object from the terminal apparatus 20 (S10), the search unit 13 searches the video index information stored in the storage unit 11 on the basis of the search key acquired in S10 (S11). Then, the search apparatus 10 transmits the search result to the terminal apparatus 20 (S12).

According to the search system of the present example embodiment that can perform a search using the motion of the object as a key, the desired scene can be searched by an approach not present in the related art.

<Second Example Embodiment>

In a search system of the present example embodiment, the video index information further indicates a temporal change of the motion of the object. For example, in a case of a scene including a state where the person approaches the bag and then, leaves while carrying the bag, the correspondence information in which information in which “person (type of object)”, “bag (type of object)”, and “approaching each other (motion of object)” are associated is associated with information in which “person (type of object)”, “bag (type of object)”, and “accompanying (motion of object)” are associated in this order (in a time series order) is stored in the storage unit 11.

The acquisition unit 12 acquires the search key indicating the type of object as a search target and the temporal change of the motion of the object. Then, the search unit 13 searches for the correspondence information matching the search key. Other configurations of the search system of the present example embodiment are the same as the configurations of the first example embodiment.

According to the search system of the present example embodiment, the same advantageous effect as the first example embodiment can be achieved. In addition, since the search can be performed by further using not only the motion of the object but also the temporal change of the motion of the object as a key, the desired scene can be searched with higher accuracy.

<Third Example Embodiment>

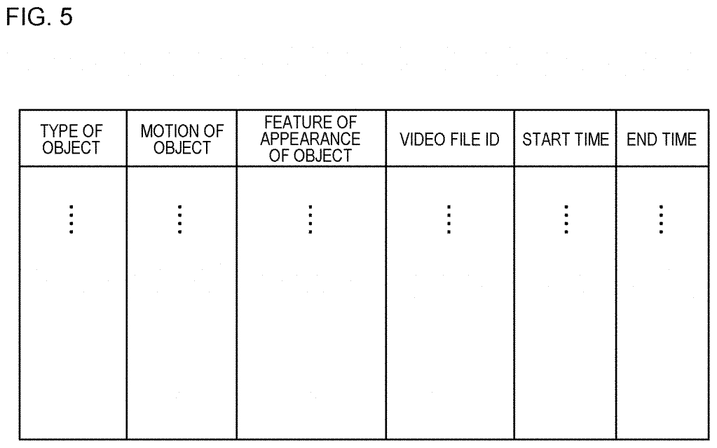

In a search system of the present example embodiment, the video index information further includes a feature of the appearance of each object extracted from the video (refer to FIG. 5). The feature of the appearance in a case where the object is a person is illustrated by a feature of a face, a sex, an age group, a nationality, a body type, a feature of an object worn on the body, or the like but is not for limitation purposes. For example, the feature of the face can be represented using a part of the face. Details of the feature of the face are not limited. For example, the feature of the object worn on the body is represented by a type, a color, a design, a shape, or the like such as a blue cap, black pants, a white skirt, or black high heels. The feature of the appearance in a case where the object is an object other than the person is illustrated by a color, a shape, a size, or the like but is not for limitation purposes.

For example, in a case of a scene including a state where a man in his 50s approaches a black bag and then, leaves while carrying the bag, the correspondence information in which information in which “person (type of object)—man in his 50s (feature of appearance)”, “bag (type of object)—black (feature of appearance)”, and “approaching each other (motion of object)” are associated is associated with information in which “person (type of object)—man in his 50s (feature of appearance)”, “bag (type of object)—black (feature of appearance)”, and “accompanying (motion of object)” are associated in this order (in a time series order) is stored in the storage unit 11.

The acquisition unit 12 acquires the search key that associates the type of one or a plurality of objects as a search target, the motion of the object (or the temporal change of the motion), and the feature of the appearance of the object. Then, the search unit 13 searches for the correspondence information matching the search key. Other configurations of the search system of the present example embodiment are the same as the configurations of the first and second example embodiments.

According to the search system of the present example embodiment, the same advantageous effect as the first and second example embodiments can be achieved. In addition, since the search can be performed by further using not only the motion of the object or the temporal change of the motion of the object but also the feature of the appearance of the object as a key, the desired scene can be searched with higher accuracy.

<Fourth Example Embodiment>

In the present example embodiment, a process of the search apparatus 10 will be described in further detail. For example, the video is continuously captured by the surveillance camera fixed at a certain position.

First, one example of a data structure processed by the search apparatus 10 will be described in detail.

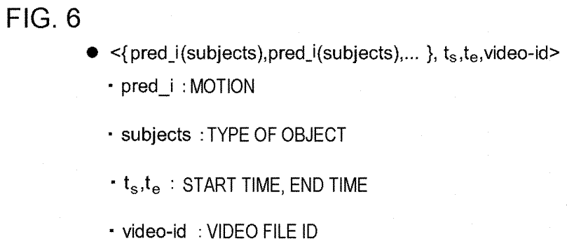

FIG. 6 illustrates one example of a data representation of the correspondence information stored in the storage unit 11. The correspondence information is generated for each scene and is stored in the storage unit 11. The ID of the video file including each scene is denoted by video-id. Information (the elapsed time from the head of the video file, the start time, or the like) indicating a start position of each scene is denoted by tₛ. Information (the elapsed time from the head of the video file, the end time, or the like) indicating an end position of each scene is denoted by tₑ.

The type of object detected from each scene is denoted by subjects. For example, a specific value thereof is a person, a dog, a cat, a bag, a car, a motorcycle, a bicycle, a bench, or a post, or a code corresponding thereto but is not for limitation purposes.

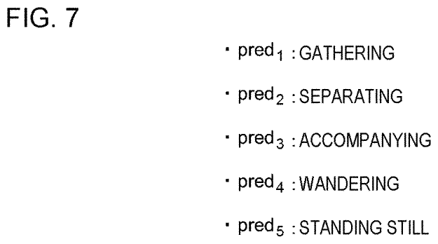

The motion, in each scene, of the object detected from each scene is denoted by pred_i. FIG. 7 illustrates types of pred_i. Note that the illustrated types are merely one example and are not for limitation purposes.

pred₁ corresponds to “gathering”, that is, a motion in which a plurality of objects approach each other.

pred₂ corresponds to “separating”, that is, a motion in which a plurality of objects move away from each other.

pred₃ corresponds to “accompanying”, that is, a motion in which a plurality of objects maintain a certain distance from each other.

pred₄ corresponds to “wandering”, that is, a motion in which the object is wandering.

pred₅ corresponds to “standing still”, that is, a motion in which the object is standing still.

Note that in a case where these five types are present, for example, the following scenes can be represented.

First, according to “pred₁: gathering: a motion in which a plurality of objects approach each other”, for example, a scene in which persons meet, a scene in which a certain person approaches another person, a scene in which a person following another person catches up with the other person, a scene in which a person approaches and holds an object (example, a bag), a scene in which a certain person receives an object, a scene in which a person approaches and rides on a car, a scene in which cars collide, or a scene in which a car collides with a person can be represented.

According to “pred₂: separating: a motion in which a plurality of objects move away from each other”, for example, a scene in which persons separate, a scene of a group of a plurality of persons, a scene in which a person throws or disposes of an object (example, a bag), a scene in which a certain person escapes from another person, a scene in which a person gets off and moves away from a car, a scene in which a certain car escapes from a car with which the car collides, or a scene in which a certain car escapes from a person with which the car collides can be represented.

According to “pred₃: accompanying: a motion in which a plurality of objects maintain a certain distance from each other”, for example, a scene in which persons walk next to each other, a scene in which a certain person tails while maintaining a certain distance with another person, a scene in which a person walks while carrying an object (example: a bag), a scene in which a person moves while riding on an animal (example, a horse), or a scene in which cars race can be represented.

According to “pred₄: wandering: a motion in which an object is wandering”, for example, a scene in which a person or a car loiters in a certain area, or a scene in which a person is lost can be represented.

According to “pred₅: standing still: a motion in which an object is standing still”, for example, a scene in which a person is at a standstill, a scene in which a person is sleeping, a scene in which a broken car, a person who loses consciousness and falls down, a person who cannot move due to a bad body condition and needs help, an object that is illegally discarded at a certain location, or the like is captured can be represented.

A representation of pred_i(subjects) means that pred_i and subjects are associated with each other. That is, it is meant that subjects performs the associated motion of pred_i.

In curly brackets: { }, one or a plurality of pred_i(subjects) can be described. The plurality of pred_i(subjects) are arranged in a time series order.

The correspondence information will be described using specific examples.

Example 1: <{pred₅(person)}, 00:02:25, 00:09:01, vid2>

The correspondence information of Example 1 indicates that a “scene in which a person is standing still” is present in 00:02:25 to 00:09:01 of the video file of vid2.

Example 2: <{pred₅(person), pred₄(person)}, 00:09:15, 00:49:22, vid1>

The correspondence information of Example 2 indicates that a “scene in which a person is standing still, and then, the person is wandering” is present in 00:09:15 to 00:49:22 of the video file of vid1.

Example 3: <{pred₁(person, bag), pred₃(person, bag)}, 00:49:23, 00:51:11, vid1>

The correspondence information of Example 3 indicates that a “scene in which a person and a bag approach each other, and then, the person accompanies the bag” is present in 00:49:23 to 00:51:11 of the video file of vid1.

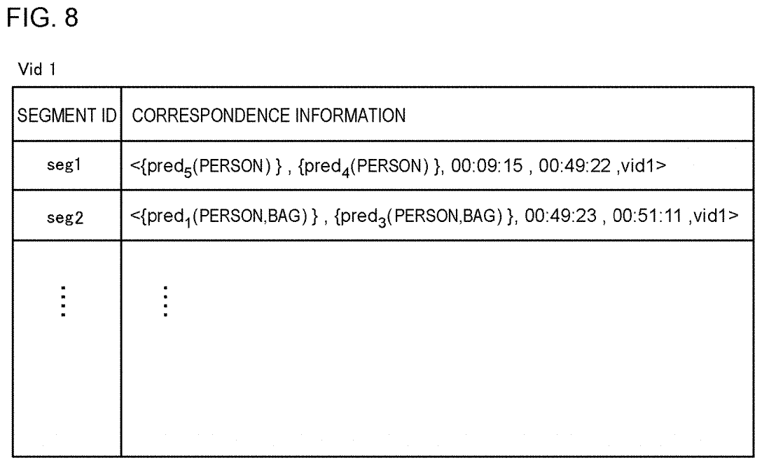

For example, as illustrated in FIG. 8, the correspondence information may be collectively stored in the storage unit 11 for each video file. The illustrated correspondence information is the correspondence information generated based on the video file of vid1. A segment ID has the same meaning as information for identifying each scene.

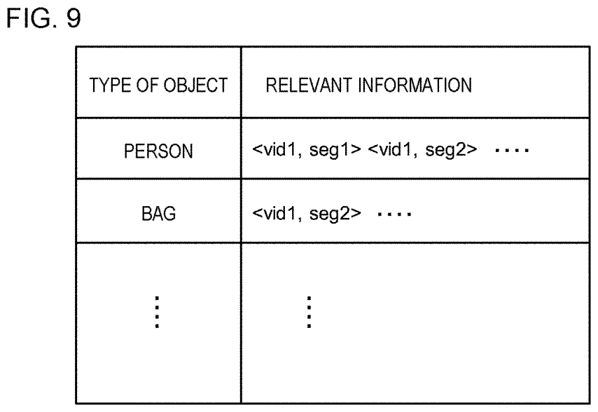

The storage unit 11 may also store information illustrated in FIG. 9. In the illustrated information, a pair of the video ID and the segment ID is associated with each type of object. That is, information for identifying a scene in which each object is captured is associated with each type of object. From the drawing, it is perceived that the “person” is captured in a scene of seg1 of the video file of vid1, a scene of seg2 of the video file of vid1, and the like. In addition, it is perceived that the “bag” is captured in the scene of seg2 of the video file of vid1 and the like.

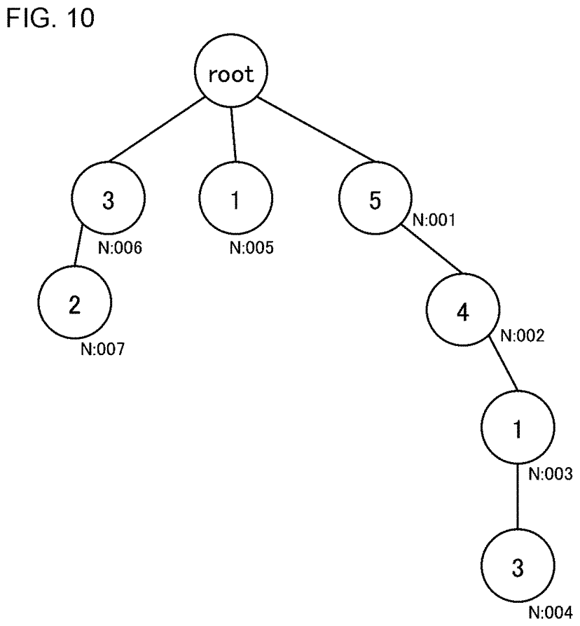

The storage unit 11 may also store index information that indicates the temporal change of the motion of the object extracted from the video in a tree structure. FIG. 10 conceptually illustrates one example of the index information. The index information of the tree structure indicates the temporal change of the motion of the object extracted from the video. Each node corresponds to one motion. A number in the node denotes the motion of the object. The number in the node corresponds to “i” of “pred_i”. That is, “1” is “gathering”, “2” is “separating”, “3” is “accompanying”, “4” is “wandering”, and “5” is “standing still”. In a case of the example in FIG. 10, it is perceived that a scene of “gathering (1)”, a scene in which “standing still→wandering→gathering→accompanying (5→4→1→3)” occurs in this order, a scene in which “accompanying→separating (3→2)” occurs in this order, and a scene in which “standing still→wandering→standing still (5→4→5)” occurs in this order are present in the video.

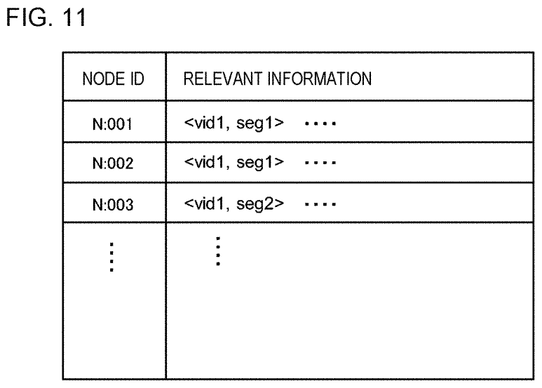

Anode ID (N:001 and the like) is assigned to each node. As illustrated in FIG. 11, for each node, the pair of the video ID and the segment ID, which corresponds to the motion of the node, appearing in the flow of motion illustrated in FIG. 10 is registered. For example, for a node of N:002, the pair of the video ID and the segment ID for identifying a scene of “wandering (4)” that appears in the flow of “standing still→wandering→gathering→accompanying (5→4→1→3)” among the scenes of “wandering (4)” present in the video is registered.

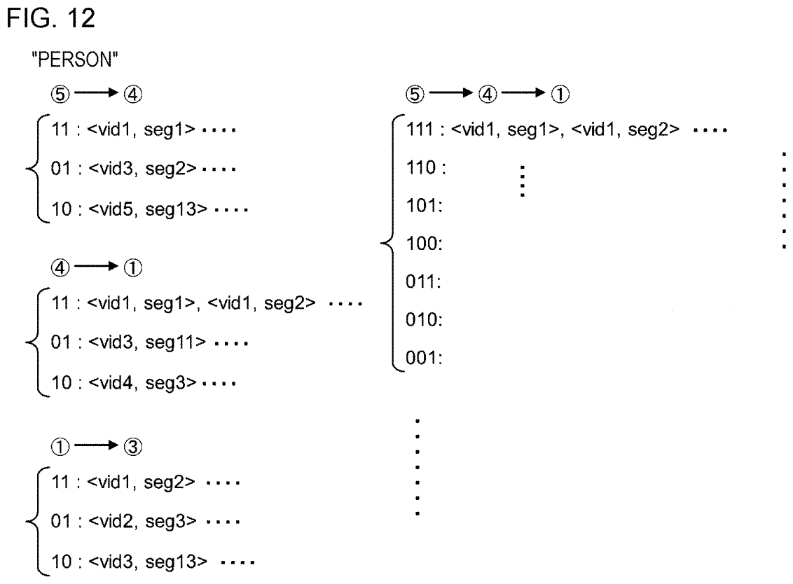

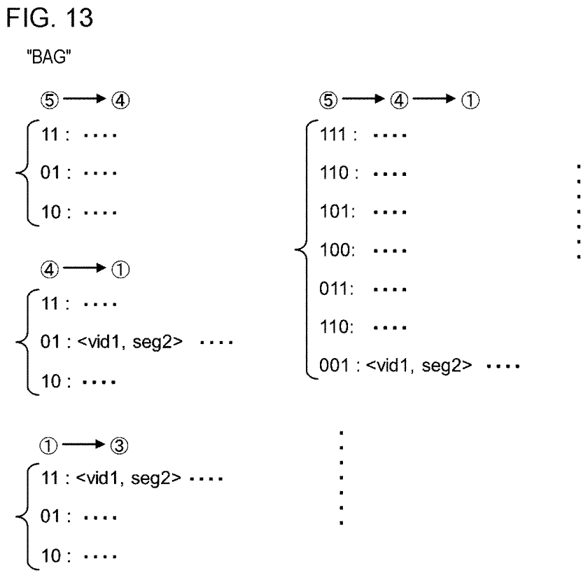

In a case where the index information of the tree structure illustrated in FIG. 10 is used, information illustrated in FIG. 12 and FIG. 13 can be generated. The illustrated information is generated for each type of object. The information indicates whether or not each object appears in a scene showing the temporal change of the motion for each combination (the temporal change of the motion) in the flow of nodes illustrated by the tree structure in FIG. 10. In a case where the object appears, the pair of the video ID and the segment ID indicating the scene is associated.

In FIG. 12, “11”, “01”, and “10” associated with 5→4 denote whether or not the person appears in a scene in which the motion has a change of “standing still (5)”→“wandering (4)”. The figure on the left side corresponds to the node of 5, and the figure on the right side corresponds to the node of 4. In a case where the person appears in a scene in which the motion is “standing still (5)”, the figure on the left side is set to “1”. In a case where the person does not appear, the figure on the left side is set to “0”. In addition, in a case where the person appears in a scene in which the motion is “wandering (4)”, the figure on the right side is set to “1”. In a case where the person does not appear, the figure on the right side is set to “0”.

In FIG. 12, “111”, . . . “001” associated with 5→4→1 denote whether or not the person appears in a scene in which the motion has a change of “standing still (5)”→“wandering (4)”→“gathering (1)”. The leftmost figure corresponds to the node of 5. The middle figure corresponds to the node of 4. The rightmost figure corresponds to the node of 1. In a case where the person appears in a scene in which the motion is “standing still (5)”, the figure at the left end is set to “1”. In a case where the person does not appear, the figure at the left end is set to “0”. In addition, in a case where the person appears in a scene in which the motion is “wandering (4)”, the middle figure is set to “1”. In a case where the person does not appear, the middle figure is set to “0”. In addition, in a case where the person appears in a scene in which the motion is “gathering (1)”, the figure at the right end is set to “1”. In a case where the person does not appear, the figure at the right end is set to “0”.

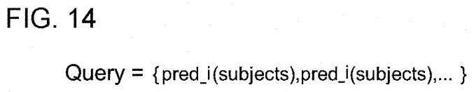

FIG. 14 illustrates one example of a data representation of the search key (Query) acquired by the acquisition unit 12. The data representation is the same as the content of the curly brackets: { } of the correspondence information described using FIG. 6.

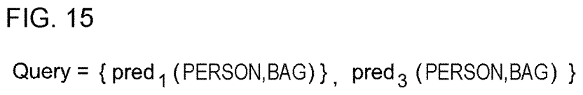

Next, a search process of the search unit 13 will be specifically described. It is assumed that the acquisition unit 12 acquires the search key illustrated in FIG. 15. This search key indicates the temporal change of the motion of “gathering (1)→“accompanying (3)”. In addition, it is perceived that the person and the bag appear in the both of a scene in which the motion is “gathering (1)” and a scene in which the motion is accompanying (3)”.

In this case, the search unit 13 uses the information illustrated in FIG. 12 and FIG. 13 as a search destination and extracts pairs of the video ID and the segment ID associated with the temporal change of the motion of 1→3 and “11” from the information (FIG. 12) corresponding to the person. In a case of the illustrated example, a pair of <vid1, seg2> and the like are extracted. In addition, the search unit 13 extracts pairs of the video ID and the segment ID associated with the temporal change of the motion of 1→3 and “11” from the information (FIG. 13) corresponding to the bag. In the case of the illustrated example, the pair of <vid1, seg2> and the like are extracted. Then, a pair that is included in both of the pairs of the video ID and the segment ID extracted from the information (FIG. 12) corresponding to the person and the pairs of the video ID and the segment ID extracted from the information (FIG. 13) corresponding to the bag is extracted as a search result.

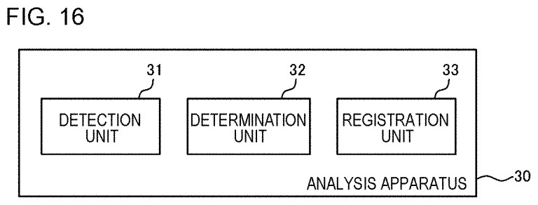

Note that the above data stored in the storage unit 11 may be automatically generated by causing a computer to analyze the video, or may be generated by causing a person to analyze the video. Hereinafter, a functional configuration of the analysis apparatus that analyzes the video and generates the above data stored in the storage unit 11 will be described. FIG. 16 illustrates one example of a function block diagram of an analysis apparatus 30. As illustrated, the analysis apparatus 30 includes a detection unit 31, a determination unit 32, and a registration unit 33.

The detection unit 31 detects various objects from the video on the basis of information that indicates the feature of the appearance of each of a plurality of types of objects.

The determination unit 32 determines to which of a plurality of predefined motions the object detected by the detection unit 31 corresponds. The plurality of predefined motions may be indicated by a change of a relative positional relationship between a plurality of objects. For example, the plurality of predefined motions may include at least one of a motion in which a plurality of objects approach each other (pred₁: gathering), a motion in which a plurality of objects move away from each other (pred₂: separating), a motion in which a plurality of objects maintain a certain distance from each other (pred₃: accompanying), wandering (pred₄: wandering), and standing still (pred₅: standing still).

For example, in a case where a distance between a plurality of objects present in the same scene is decreased along with an elapse of time, the determination unit 32 may determine that the motions of the plurality of objects are “pred₁: gathering”.

In a case where a distance between a plurality of objects present in the same scene is increased along with an elapse of time, the determination unit 32 may determine that the motions of the plurality of objects are “pred₂: separating”.

In a case where a distance between a plurality of objects present in the same scene is maintained within a predetermined distance for a certain amount of time, the determination unit 32 may determine that the motions of the plurality of objects are “pred₃: accompanying”.

In a case where a certain object continues moving in an area within a predetermined distance L1 from a reference position, the determination unit 32 may determine that the motion of the object is “pred₄: wandering”.

In a case where a certain object continues staying in an area within a predetermined distance L2 from a reference position (L1>L2), the determination unit 32 may determine that the motion of the object is “pred₅: standing still”.

Note that reference criteria described here are merely one example, and other reference criteria may also be employed.

The registration unit 33 registers data (pred_i(subjects)) in which the type of object detected by the detection unit 31 and the motion of each object determined by the determination unit 32 are associated.

Note that the registration unit 33 can further register the start position and the end position of the scene in association with the data. A method of deciding the start position and the end position of the scene is a design matter. For example, a timing at which a certain object is detected from the video may be set as the start position of the scene, and a timing at which the object is not detected anymore may be set as the end position of the scene. A certain scene and another scene may partially overlap or may be set to not overlap. Consequently, information illustrated in FIG. 8 is generated for each video file, and information illustrated in FIG. 9 to FIG. 13 is generated based on the generated information.

A modification example of the present example embodiment will be described. In addition to the person, the dog, the cat, the bag, the car, the motorcycle, the bicycle, the bench, or the post, or the code corresponding thereto, the value of subjects (refer to FIG. 6) of the correspondence information may include a categorization code with which various objects are further categorized in detail depending on the appearance. For example, the value of subjects may be represented as person(h000001), bag(b000001), or the like. The value in the brackets is the categorization code. In a case where the object is the person, the categorization code means an identification code for identifying an individual person captured in the video. In a case where the object is the bag, the categorization code is information for identifying each group of a collection of bags having the same or similar shape, size, design, color, design, or the like. The same applies to a case of other objects. While illustration is not provided, the storage unit 11 may store information indicating the feature of the appearance for each categorization code.

In a case of the modification example, the acquisition unit 12 can acquire the search key that includes the type of object as a search target, the motion or the temporal change of the motion of the object, and the feature of the appearance of the object. The search unit 13 can convert the feature of the appearance included in the search key into the categorization code and search for a scene in which various objects of the categorization code have the motion or the temporal change of the motion indicated by the search key.

Note that in the case of the modification example, a process of grouping objects having the same or similar appearances among various objects extracted from each frame and assigning the categorization code to each group is necessary. Hereinafter, one example of the process will be described.

First, an object is extracted from each of a plurality of frames. Then, a determination as to whether or not the appearances of the object (example: person) of a first type extracted from a certain frame and an object (example: person) of the first type extracted from the previous frame are similar to a predetermined level or more is performed, and the objects that are similar to the predetermined level or more are grouped. The determination may also be performed by comparing all pairs of the feature of the appearance of each of all objects (example: person) of the first type extracted from the previous frame and the feature of the appearance of each of all objects (example: person) of the first type extracted from the certain frame. However, in a case of this process, as accumulated data of the object is increased, the number of pairs to be compared is significantly increased, and a processing load is increased. Therefore, for example, the following method may be employed.

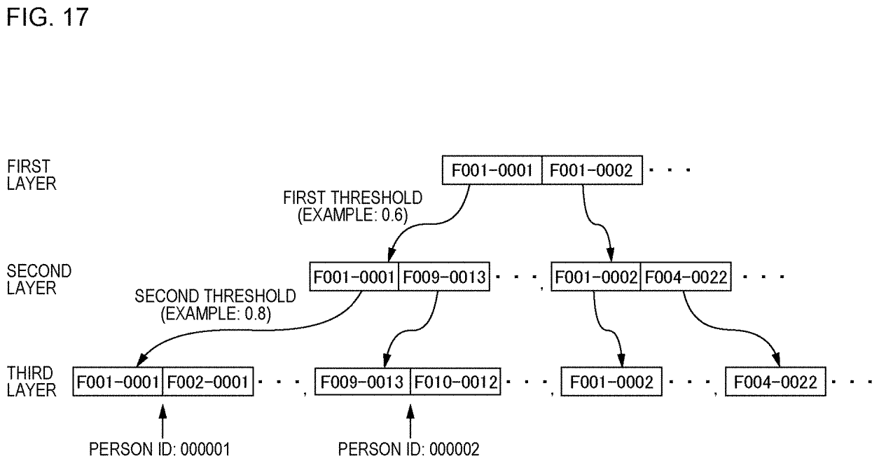

For example, the extracted object is indexed for each type of object as in FIG. 17, and the objects having the appearances similar to the predetermined level or more are grouped using the index. Details and a generation method of the index are disclosed in Patent Documents 2 and 3 and will be briefly described below. While the person is described as an example here, the same process can be employed in a case where the type of object is another object.

An extraction ID: “F000-0000” illustrated in FIG. 17 is identification information that is assigned to each person extracted from each frame. F000 is frame identification information, and the part after the hyphen is identification information of each person extracted from each frame. In a case where the same person is extracted from different frames, different extraction IDs are assigned to the person in each frame.

In a third layer, a node that corresponds to each of all extraction IDs obtained from the frames processed thus far is arranged. Among the plurality of nodes arranged in the third layer, nodes having a similarity (a similarity of a feature value of the appearance) higher than or equal to a first level are grouped. In the third layer, a plurality of extraction IDs that are determined as being related to the same person are grouped. That is, the first level of the similarity is set to a value that allows such grouping. Person identification information (person ID: categorization ID of the person) is assigned in association with each group of the third layer.

In a second layer, one node (representative) that is selected from each of the plurality of groups of the third layer is arranged and is linked to the group of the third layer. Among the plurality of nodes arranged in the second layer, nodes having the similarity higher than or equal to a second level are grouped. Note that the second level of the similarity is lower than the first level. That is, nodes that are not grouped in a case where the first level is used as a reference may be grouped in a case where the second level is used as a reference.

In a first layer, one node (representative) that is selected from each of the plurality of groups of the second layer is arranged and is linked to the group of the second layer.

In a case where a new extraction ID is obtained from a new frame, first, the plurality of extraction IDs positioned in the first layer are used as a comparison target. That is, pairs are created between the new extraction ID and each of the plurality of extraction IDs positioned in the first layer. Then, the similarity (the similarity of the feature value of the appearance) is computed for each pair, and a determination as to whether or not the computed similarity is higher than or equal to a first threshold (similar to the predetermined level or more) is performed.

In a case where the extraction ID having the similarity higher than or equal to the first threshold is not present in the first layer, it is determined that a person corresponding to the new extraction ID is not the same person as the person previously extracted. Then, the new extraction ID is added to the first layer to the third layer, and the added extraction IDs are linked to each other. In the second layer and the third layer, a new group is generated by the added new extraction ID. In addition, a new person ID is issued in association with the new group of the third layer. The person ID is determined as a person ID of the person corresponding to the new extraction ID.

On the other hand, in a case where the extraction ID having the similarity higher than or equal to the first threshold is present in the first layer, the comparison target is moved to the second layer. Specifically, a group of the second layer that is linked to the “extraction ID of the first layer determined as having the similarity higher than or equal to the first threshold” is used as the comparison target.

Then, pairs are created between the new extraction ID and each of the plurality of extraction IDs included in a processing target group of the second layer. Next, the similarity is computed for each pair, and a determination as to whether or not the computed similarity is higher than or equal to a second threshold is performed. Note that the second threshold is higher than the first threshold.

In a case where the extraction ID having the similarity higher than or equal to the second threshold is not present in the processing target group of the second layer, it is determined that the person corresponding to the new extraction ID is not the same person as the person previously extracted. Then, the new extraction ID is added to the second layer and the third layer, and the added extraction IDs are linked to each other. In the second layer, the new extraction ID is added to the processing target group. In the third layer, a new group is generated by the added new extraction ID. In addition, a new person ID is issued in association with the new group of the third layer. The person ID is determined as a person ID of the person corresponding to the new extraction ID.

On the other hand, in a case where the extraction ID having the similarity higher than or equal to the second threshold is present in the processing target group of the second layer, it is determined that the person corresponding to the new extraction ID is the same person as the person previously extracted. Then, the new extraction ID is set to belong to a group of the third layer that is linked to the “extraction ID of the second layer determined as having the similarity higher than or equal to the second threshold”. In addition, a person ID corresponding to the group of the third layer is determined as a person ID of the person corresponding to the new extraction ID.

For example, as described above, one or a plurality of extraction IDs extracted from a new frame can be added to the index in FIG. 17, and the person ID can be associated with each extraction ID.

According to the search system of the present example embodiment described above, the same advantageous effect as the first to third example embodiments can be achieved.

<Fifth Example Embodiment>

A functional configuration of the terminal apparatus 20 that receives the input of the search key described in the first to fourth example embodiments will be described.

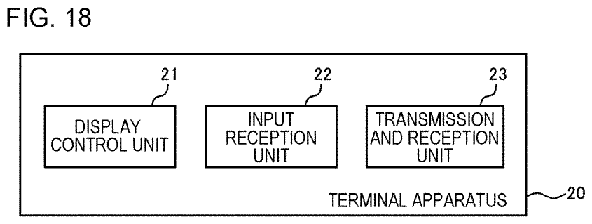

FIG. 18 illustrates one example of a function block diagram of the terminal apparatus 20. As illustrated, the terminal apparatus 20 includes a display control unit 21, an input reception unit 22, and a transmission and reception unit 23.

The display control unit 21 displays a search screen on the display. The search screen includes an icon display area in which a plurality of icons respectively indicating the plurality of predefined motions are selectably displayed, and an input area in which the input of the search key is received. Note that the search screen may further include a result display area in which the search result is displayed in a list.

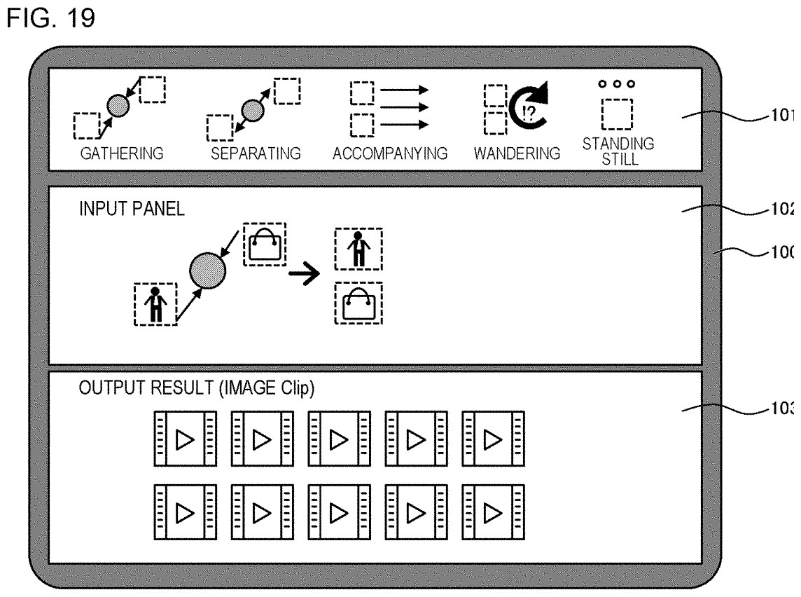

FIG. 19 schematically illustrates one example of the search screen. An illustrated search screen 100 includes an icon display area 101, an input area 102, and a result display area 103. The plurality of icons respectively indicating the plurality of predefined motions are selectably displayed in the icon display area 101. The search key input by the user is displayed in the input area 102. A plurality of videos as the search result are displayed to be able to be played back in a list in the result display area 103.

Returning to FIG. 18, the input reception unit 22 receives an operation of moving any of the plurality of icons displayed in the icon display area 101 into the input area 102. Then, the input reception unit 22 receives the motion indicated by the icon positioned in the input area 102 as a search key.

The operation of moving the icon displayed in the icon display area 101 into the input area 102 is not particularly limited. For example, the operation may be drag and drop or may be another operation.

In addition, the input reception unit 22 receives an input that specifies the type of one or a plurality of objects in association with the icon positioned in the input area 102. The type of object specified in association with the icon is received as a search key.

The operation of specifying the type of object is not particularly limited. For example, the type of object may be specified by drawing an illustration by handwriting in a dotted line quadrangle of each icon. In this case, the terminal apparatus 20 may present a figure similar to a handwritten figure as a possible input. In a case where one possible input is selected, the terminal apparatus 20 may replace the handwritten figure in the input field with the selected figure. The features of the appearances of various objects are also input by the handwritten figure. In a case where there is a photograph or an image that can clearly show the feature of the appearance, the photograph or the image may also be input.

Besides, while illustration is not provided, icons corresponding to various objects may also be selectably displayed in the icon display area 101. Then, by drag and drop or another operation, an input that specifies the type of object having each motion may be provided by moving the icons corresponding to various objects into dotted line quadrangles of icons corresponding to various motions.

Note that an input of the temporal change of the motion of the object is performed by moving the plurality of icons corresponding to various motions into the input area 102 as illustrated, and connecting the icons by arrows in a time series order as illustrated or arranging the icons in a time series order (example: from left to right).

The transmission and reception unit 23 transmits the search key received by the input reception unit 22 to the search apparatus 10 and receives the search result from the search apparatus 10. The display control unit 21 displays the search result received by the transmission and reception unit 23 in the result display area 103.

According to the search system of the present example embodiment described above, the same advantageous effect as the first to fourth example embodiments can be achieved.

In addition, for example, according to the search system of the present example embodiment that can receive the input of the search key from a user-friendly graphical user interface (GUI) screen illustrated in FIG. 19, an input load of the search key for the user can be reduced.

<Hardware Configuration of Each Apparatus>

Last, one example of a hardware configuration of each of the search apparatus 10, the terminal apparatus 20, and the analysis apparatus 30 will be described. Each unit included in each of the search apparatus 10, the terminal apparatus 20, and the analysis apparatus 30 is implemented by any combination of hardware and software mainly based on a central processing unit (CPU) of any computer, a memory, a program loaded into the memory, a storage unit (can store not only a program that is stored in advance from a stage of shipment of the apparatuses but also a program that is downloaded from a storage medium such as a compact disc (CD) or a server or the like on the Internet) such as a hard disk storing the program, and a network connection interface. Those skilled in the art will perceive various modification examples of an implementation method thereof and the apparatuses.

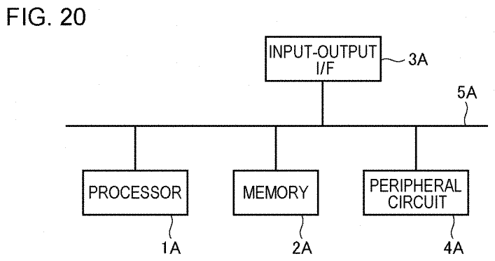

FIG. 20 is a block diagram illustrating a hardware configuration of each of the search apparatus 10, the terminal apparatus 20, and the analysis apparatus 30 of the present example embodiment. As illustrated in FIG. 20, each of the search apparatus 10, the terminal apparatus 20, and the analysis apparatus 30 includes a processor 1A, a memory 2A, an input-output interface 3A, a peripheral circuit 4A, and a bus 5A. The peripheral circuit 4A includes various modules. Note that the peripheral circuit 4A may not be included.

The bus 5A is a data transfer path for transmitting and receiving data among the processor 1A, the memory 2A, the peripheral circuit 4A, and the input-output interface 3A. The processor 1A is an arithmetic processing unit such as a central processing unit (CPU) or a graphics processing unit (GPU). The memory 2A is a memory such as a random access memory (RAM) or a read only memory (ROM). The input-output interface 3A includes an interface for acquiring information from an input device (example: a keyboard, a mouse, a microphone, or the like), an external apparatus, an external server, an external sensor, or the like, an interface for outputting information to an output device (example: a display, a speaker, a printer, a mailer, or the like), the external apparatus, the external server, or the like. The processor 1A can provide an instruction to each module and perform a calculation based on a calculation result of the module.

Reference example embodiments are appended below.

1. A search apparatus including:

a storage unit that stores video index information including correspondence information which associates a type of one or a plurality of objects extracted from a video with a motion of the object;

an acquisition unit that acquires a search key associating the type of one or the plurality of objects as a search target with the motion of the object; and

a search unit that searches the video index information on the basis of the search key.

2. The search apparatus according to 1,

in which the correspondence information includes types of the plurality of objects, and

motions of the plurality of objects are indicated by a change of a relative positional relationship between the plurality of objects.

3. The search apparatus according to 2,

in which the motions of the plurality of objects include at least one of a motion in which the plurality of objects approach each other, a motion in which the plurality of objects move away from each other, and a motion in which the plurality of objects maintain a certain distance from each other.

4. The search apparatus according to any one of 1 to 3,

in which the motion of the object includes at least one of standing still and wandering.

5. The search apparatus according to any one of 1 to 4,

in which the video index information further indicates a temporal change of the motion of the object, and

the acquisition unit acquires the search key that further indicates the temporal change of the motion of the object as the search target.

6. The search apparatus according to any one of 1 to 5,

in which the video index information further includes a feature of an appearance of the object, and

the acquisition unit acquires the search key that further indicates the feature of the appearance of the object as the search target.

7. The search apparatus according to any one of 1 to 6,

in which the correspondence information further includes information for identifying a video file from which each object having each motion is extracted, and a position in the video file.

8. A terminal apparatus including:

a display control unit that displays a search screen on a display, the search screen including an icon display area which selectably displays a plurality of icons respectively indicating a plurality of predefined motions, and an input area which receives an input of a search key;

an input reception unit that receives an operation of moving any of the plurality of icons into the input area and receives a motion indicated by the icon positioned in the input area as the search key; and

a transmission and reception unit that transmits the search key to a search apparatus and receives a search result from the search apparatus.

9. The terminal apparatus according to 8,

in which the input reception unit receives an input that specifies a type of one or a plurality of objects in association with the icon positioned in the input area, and receives the specified type of object as the search key.

10. An analysis apparatus including:

a detection unit that detects an object from a video on the basis of information indicating a feature of an appearance of each of a plurality of types of objects;

a motion determination unit that determines to which of a plurality of predefined motions the detected object corresponds; and

a registration unit that registers the type of object detected by the detection unit in association with a motion of each object determined by the determination unit.

11. The analysis apparatus according to 10,

in which the plurality of predefined motions are indicated by a change of a relative positional relationship between the plurality of objects.

12. The analysis apparatus according to 11,

in which the plurality of predefined motions include at least one of a motion in which the plurality of objects approach each other, a motion in which the plurality of objects move away from each other, and a motion in which the plurality of objects maintain a certain distance from each other.

13. The analysis apparatus according to any one of 10 to 12,

in which the plurality of predefined motions include at least one of standing still and wandering.

14. A search method executed by a computer, the method including:

storing video index information including correspondence information that associates a type of one or a plurality of objects extracted from a video with a motion of the object;

an acquisition step of acquiring a search key associating the type of one or the plurality of objects as a search target with the motion of the object; and

a search step of searching the video index information on the basis of the search key.

15. A program causing a computer to function as:

a storage unit that stores video index information including correspondence information that associates a type of one or a plurality of objects extracted from a video with a motion of the object;

an acquisition unit that acquires a search key associating the type of one or the plurality of objects as a search target with the motion of the object; and

a search unit that searches the video index information on the basis of the search key.

16. An operation method of a terminal apparatus executed by a computer, the method including:

a display control step of displaying a search screen on a display, the search screen including an icon display area which selectably displays a plurality of icons respectively indicating a plurality of predefined motions, and an input area which receives an input of a search key;

an input reception step of receiving an operation of moving any of the plurality of icons into the input area and receiving a motion indicated by the icon positioned in the input area as the search key; and

a transmission and reception step of transmitting the search key to a search apparatus and receiving a search result from the search apparatus.

17. A program causing a computer to function as:

a display control unit that displays a search screen on a display, the search screen including an icon display area which selectably displays a plurality of icons respectively indicating a plurality of predefined motions, and an input area which receives an input of a search key;

an input reception unit that receives an operation of moving any of the plurality of icons into the input area and receives a motion indicated by the icon positioned in the input area as the search key; and

a transmission and reception unit that transmits the search key to a search apparatus and receives a search result from the search apparatus.

18. An analysis method executed by a computer, the method including:

a detection step of detecting, on the basis of information indicating a feature of an appearance of each of a plurality of types of objects, the object from a video;

a motion determination step of determining to which of a plurality of predefined motions the detected object corresponds, and

a registration step of registering the type of object detected in the detection step in association with a motion of each object determined in the determination step.

19. A program causing a computer to function as:

a detection unit that detects, on the basis of information indicating a feature of an appearance of each of a plurality of types of objects, the object from a video;

a motion determination unit that determines to which of a plurality of predefined motions the detected object corresponds; and

a registration unit that registers the type of object detected by the detection unit in association with a motion of each object determined by the determination unit.

This application claims the benefit of priority based on Japanese Patent Application No. 2017-200103 filed on Oct. 16, 2017, the entire disclosure of which is incorporated herein.

1. A search apparatus comprising:
at least one memory configured to store one or more instructions; and
at least one processor configured to execute the one or more instructions to:
store video index information including correspondence information which associates a type of one or a plurality of objects extracted from a video with a motion of the object;
acquires acquire a search key associating the type of one or the plurality of objects as a search target with the motion of the object; and
search the video index information on the basis of the search key.

2. The search apparatus according to claim 1,
wherein the correspondence information includes types of the plurality of objects, and
motions of the plurality of objects are indicated by a change of a relative positional relationship between the plurality of objects.

3. The search apparatus according to claim 2,
wherein the motions of the plurality of objects include at least one of a motion in which the plurality of objects approach each other, a motion in which the plurality of objects move away from each other, and a motion in which the plurality of objects maintain a certain distance from each other.

4. The search apparatus according to claim 1,
wherein the motion of the object includes at least one of standing still and wandering.

5. The search apparatus according to claim 1,
wherein the video index information further indicates a temporal change of the motion of the object, and
wherein the processor is further configured to execute the one or more instructions to acquire the search key that further indicates the temporal change of the motion of the object as the search target.

6. The search apparatus according to claim 1,
wherein the video index information further includes a feature of an appearance of the object, and
wherein the processor is further configured to execute the one or more instructions to acquire the search key that further indicates the feature of the appearance of the object as the search target.

7. The search apparatus according to claim 1,
wherein the correspondence information further includes information for identifying a video file from which each object having each motion is extracted, and a position in the video file.

8-13. (canceled)

14. A search method executed by a computer, the method comprising:
storing video index information including correspondence information that associates a type of one or a plurality of objects extracted from a video with a motion of the object;
acquiring a search key associating the type of one or the plurality of objects as a search target with the motion of the object; and
searching the video index information on the basis of the search key.

15. A non-transitory storage medium storing a program causing a computer to:
store video index information including correspondence information that associates a type of one or a plurality of objects extracted from a video with a motion of the object;
acquire a search key associating the type of one or the plurality of objects as a search target with the motion of the object; and
search the video index information on the basis of the search key.

16-19. (canceled)
